(19) United States
(12) Patent Application Publication
(10) Pub. No.: US 2007/0058611 A1
(43) Pub. Date: Mar. 15, 2007

(54) Method and system to proxy mobile and network originated call sessions

(75) Inventors: Anil Doradla, Austin, TX (US); Sreenivasa Gorti, Austin, TX (US); Dave Wolter, Austin, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/226,583

(22) Filed: Sep. 14, 2005

(51) Int. Cl. H04L 12/66; H04L 12/56

(52) U.S. Cl. 370/352; 370/401

(57) ABSTRACT

A method (300) and system (100) are disclosed to proxy mobile and network originated call sessions. A system that incorporates teachings of the present disclosure may include, for example, a method in a network proxy (102) having the steps of receiving (308) from a mobile device (116) on a data channel (110) of a communications network 100 a mobile originated call to connect to a terminal device, transmitting (316) a first network originated call to the terminal device over a first voice channel, transmitting (324) a second network originated call to the mobile device over a second voice channel, and linking (332) the first and second voice channels. The system may also include a method in the mobile device having the steps of establishing (302) the data channel connection, transmitting (306) the mobile originated call to the network proxy, and receiving and accepting (326, 330) the second network originated call.

### FIELD OF THE DISCLOSURE

The present disclosure relates generally to communication systems, and more specifically to a method and system to proxy mobile and network originated call sessions.

### BACKGROUND

Convergence of wireless and wireline networks has been identified as one of the most important strategic areas for many telecommunications providers. One of the key components in this convergence is service availability and seamlessness across multiple communication networks. For example, most mid to large-sized enterprises offer some form of abbreviated dialing by way of a PBX (Private Branch eXchange) system or a Centrex (Central Exchange). When an enterprise user, however, enters a cellular network with a mobile phone, abbreviated dialing services of the enterprise are no longer available.

Unfortunately, due to dissimilarity in technology implementation across wireless and wireline networks, and a lack of coordination between cellular operators and enterprises, very limited success has been achieved in the integration of these two environments.

The extension of the enterprise experience over a wide area is of great importance. It is not unusual for business travelers to spend considerable amounts of time traveling often having a need to be in contact with their companies. Any effort that eases the customer experience in favor of greater integration with their enterprise is therefore highly desirable.

### BRIEF DESCRIPTION OF THE DRAWINGS

FIG. 1 is a block diagram of communication system incorporating teachings of the present disclosure;

FIG. 2 is a block diagram of a mobile device incorporating the teachings of the present disclosure;

FIG. 3 depicts a flowchart of a method operating in the communication system according to the teachings of the present disclosure; and

FIG. 4 is a diagrammatic representation of a machine in the form of a computer system within which a set of instructions, when executed, may cause the machine to perform any one or more of the methodologies discussed herein.

### DETAILED DESCRIPTION OF THE DRAWINGS

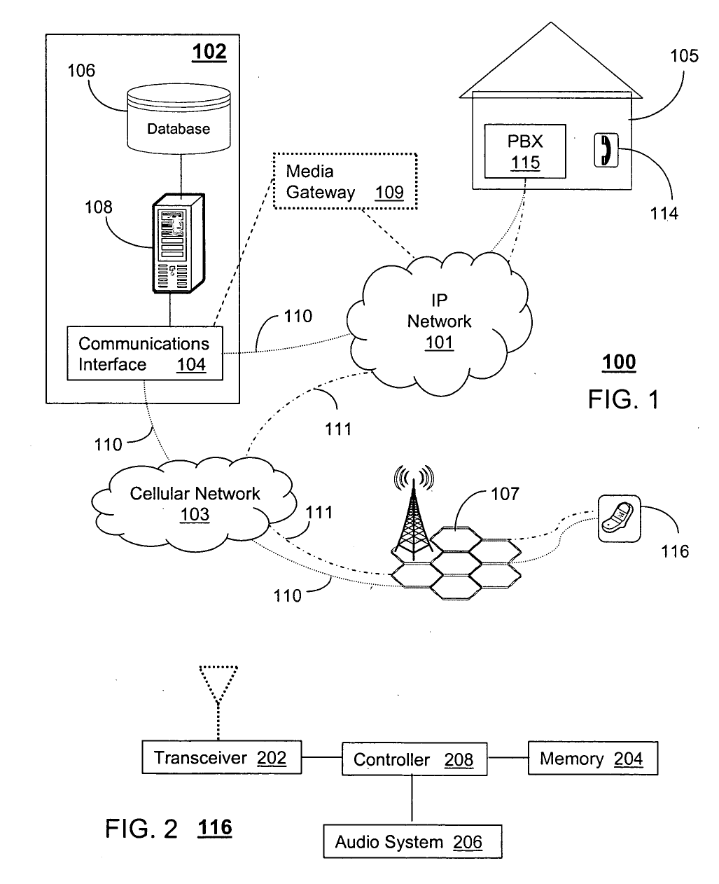

FIG. 1 is a block diagram of communication system 100 incorporating the teachings of the present disclosure. The communication system 100 comprises an IP (Internet Protocol) network 101 coupled to a network proxy 102, a cellular network 103 and an enterprise 105. The IP network 101 utilizes technology for transporting Internet traffic. The enterprise 105 can include a PBX 115 that provides connectivity services such as abbreviated dialing (e.g., 5-digit dialing) between terminal devices 114 (such as a Voice over IP phone) of enterprise personnel. Alternatively, the enterprise 105 can be coupled to a Centrex controllable by the network proxy 102 as described below for supporting similar services as the PBX 115.

It will be appreciated by an artisan with ordinary skill in the art that the present disclosure and claims described below are not limited to an enterprise setting. That is, the network proxy 102 can operate in a non-commercial setting such as for residential consumers or other non-commercial users who seek a similar experience as described herein. For illustration purposes only therefore, the following disclosure focuses on the enterprise setting. However, it would be apparent to said artisan that the claims described below can be applied to a non-commercial setting as well.

The network proxy 102 comprises a communications interface 104 that utilizes common technology for communicating over an IP interface with the IP network 101, a media gateway 109, or the cellular network 103. The network proxy 102 further comprises a memory 106 (such as a high capacity storage medium) embodied in this illustration as a database, and a controller 108 that makes use of computing technology such as a desktop computer, or scalable server for controlling operations of the network proxy 102. The network proxy 102 can operate as an IP Multimedia Subsystem (IMS) conforming in part to protocols defined by standards bodies such as 3GPP (Third Generation Partnership Protocol), and the claims described below.

Under the control of the network proxy 102, the media gateway 109 can link packet-switched and circuit-switched technologies such as the cellular network 103 and the IP network 101, respectively. The media gateway 109 can conform to a media gateway control protocol (MGCP) also known as H.248 defined by work groups in the Internet Engineering Task Force (IETF). This protocol can handle signaling and session management needed during a multimedia conference. The protocol defines a means of communication between the media gateway 109, which converts data from the format required for a circuit-switched network to that required for a packet-switched network. MGCP can therefore be used to set up, maintain, and terminate calls between multiple disparate communication elements.

The cellular network 103 utilizes circuit-switched technology supporting voice and data services such as GSM-GPRS, EDGE, CDMA-1X, UMTS, and other known technologies. The cellular network 103 is coupled to base stations 107 under a frequency-reuse environment for communicating over-the-air with roaming mobile devices 116.

FIG. 2 is a block diagram of the mobile device 116 incorporating teachings of the present disclosure. The mobile device 116 utilizes technology such as a wireless transceiver 202, a memory 204, an audio system 206, and a controller 208. The wireless transceiver 202 utilizes technology for exchanging voice and data messages with the base stations 107, which relay said messages to targeted end users. In an embodiment where the mobile device 116 is a multi-mode communication device, the wireless transceiver 202 can include technology for wireline communications (such as POTS—Plain Old Telephone Service), WiFi, WiMax, and so on. In a multi-functional embodiment, the mobile device can also serve as terminal device 114 of the enterprise 105. That is, when the mobile device 116 is within the premises of the enterprise 105 it functions as a POTS wireline device, or an IP-based device over Ethernet or WiFi. When roaming outside the enterprise the mobile device 116 functions as a wireless communication device on the external cellular network.

The controller 208 utilizes computing technology such as a microprocessor and/or digital signal processor for controlling the operations of the mobile device 116 according to the present disclosure. The memory 204 comprises storage devices such as RAM, SRAM, DRAM, and/or Flash memories. The audio system 206 includes audio technology for intercepting audio signals from a user and for conveying audio signals received by the mobile device 116.

It would be apparent to one of ordinary skill in the art that the communication technologies illustrated in FIG. 1 can be modified without departing from the scope and spirit of the claims described below. For instance, the cellular network 103 can be replaced with a WiFi or WiMax network without departing from the teachings of the present disclosure and the claims described herein.

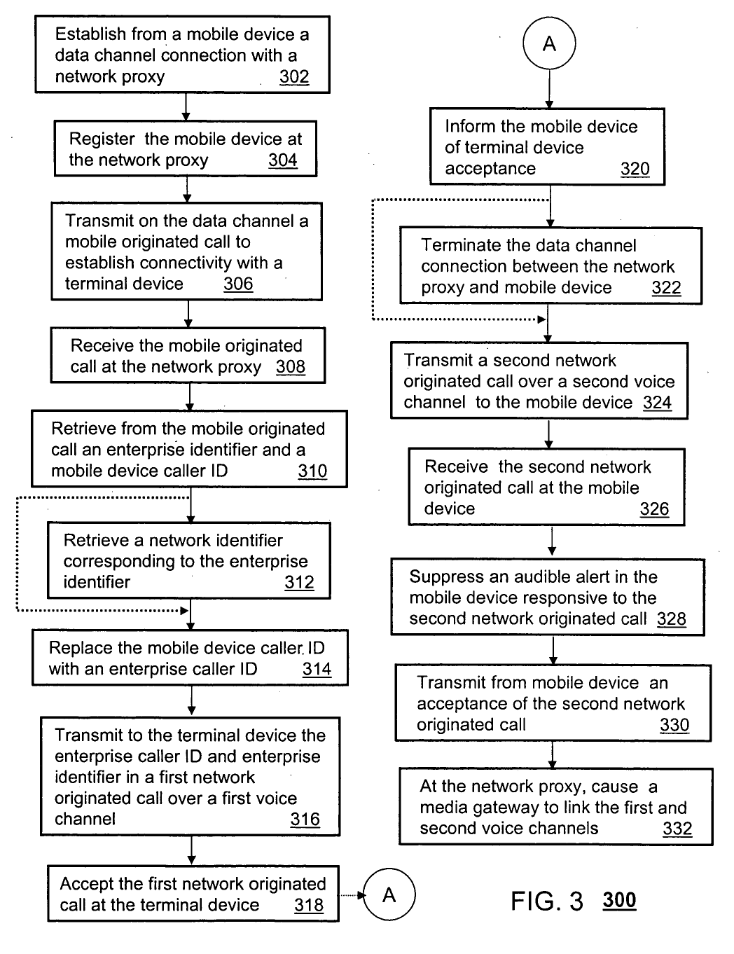

With this in mind, FIG. 3 depicts a flowchart of a method 300 operating in the communication system 100 according to the teachings of the present disclosure. Method 300 begins with step 302 where the mobile device 116 establishes a data connection 110 with the network proxy 102. The data connection can be, for instance, a GPRS session in which IP packets can be exchanged between the mobile device 116 and the network proxy 102. Upon establishing this connection, in step 304 the network proxy 102 registers the mobile device 116. The registration process can include identifying the mobile device 116 as a known user and extracting account information relating thereto from its database 106. The account information can indicate, for example, that the mobile device user is a member of enterprise 105. The database 106 can further include enterprise identifiers for conducting abbreviated dialing with personnel of the enterprise 105.

In step 306 the mobile device 116 transmits to the network proxy 102 over the data channel (such as GPRS, EDGE, CDMA-1X, UMTS etc.) details relating to a mobile originated (MO) call to establish connectivity with the terminal device 114. As part of the MO call mobile device 116 can utilize a 10-digit number or abbreviated enterprise identifier such as 6-5555 for the terminal device 114. As noted earlier, the terminal device 114 can be an enterprise user or a non-enterprise user. In either case the terminal device 114 can be any one of a variety of devices including, but not limited to, a POTS (Plain Old Telephone Service) phone, VoIP phone, wireless device, etc. This step is in response to a user of the mobile device 116 desiring to communicate with an enterprise user as if the mobile user were making the call within the enterprise 105. The network proxy 102 in step 310 retrieves from the MO call the enterprise identifier and a mobile device caller ID. If the received enterprise identifier is a 10-digit number, the network proxy 102 skips over step 312 to step 314. Otherwise, the network proxy 102 proceeds to step 312 where it retrieves a network identifier comprising a 10-digit number (e.g., 333-444-5555) corresponding to the abbreviated enterprise identifier of 6-5555.

In step 314, the network proxy 102 can replace the mobile device caller ID with an enterprise caller ID to emulate a caller ID originating from mobile user's office in the enterprise 105. In step 316, the network proxy transmits a first network originated call to the targeted terminal device 114 with the enterprise caller ID using the network identifier (i.e., 333-444-5555). The first network originating call represents the initial step in establishing of a voice call with a terminal device 114 of an enterprise (or non-enterprise) user. When the terminal device 114 accepts the call in step 318, the network proxy 102 proceeds to step 320 where it informs the mobile device 116 of the acceptance. Thereafter in step 322, the mobile device 116 and the network proxy 102 terminate the data connection. If, however, the mobile device 116 can support simultaneous voice and data connections, step 322 can be skipped, thereby providing the network proxy 102 and mobile device 116 a means to exchange further information such as telemetry information, billing information, or otherwise.

In step 324, the network proxy 102 transmits a second network originated call over a second voice channel to the mobile device 116 utilizing a signaling protocol such as SS7 (Signaling System 7). In step 326, the mobile device 116 receives the second network originated call. The mobile device 116 in step 328 suppresses an audible alert typically generated by the audio system 206 so as to not confuse the user of the mobile device 116 who initiated the call. In step 330, the mobile device 116 automatically informs the network proxy 102 that it has accepted the call. In step 332, the network proxy 102 calls upon the media gateway 109 to link the first and second voice channels by patching bearer sessions between the circuit-switched cellular network 103 and the VoIP terminal device 114 utilizing RTP (Real-time Transport Protocol) over the IP network 101 on link 111. At this point the mobile and enterprise users can conduct a conversation.

The aforementioned steps occur rapidly so that it would be imperceptible to either of the mobile and enterprise users that multiple calls sessions have taken place. Furthermore, the aforementioned steps can be implemented with computer instructions operating in part at the network proxy 102 and as a client in the mobile device 102, respectively. It should also be noted that method 300 and its variants can be employed in portions of the communication system 100 of FIG. 1 with minimal impact to the suppliers of legacy technologies illustrated therein.

It should be again emphasized that although the above description focuses on an enterprise setting, non-commercial settings are within the scope and spirit of the claims described below. It would be evident to an artisan with ordinary skill in the art that an exchange system such as a PBX or Centrex is an unnecessary element in view of the claims below. For example, the transactions described in method 300 can take place directly between the network proxy 102, the mobile device 116, and the terminal device 114 without interaction with a private exchange, or other networking element so long as a communication medium interconnecting the network proxy 102, the mobile device 116, and the terminal device 114 facilitates said transactions. It would also be evident to said artisan that the voice channels described in the present disclosure can IP-based voice channels, non-IP-based voice channels (such as circuit switched communications), or combinations thereof.

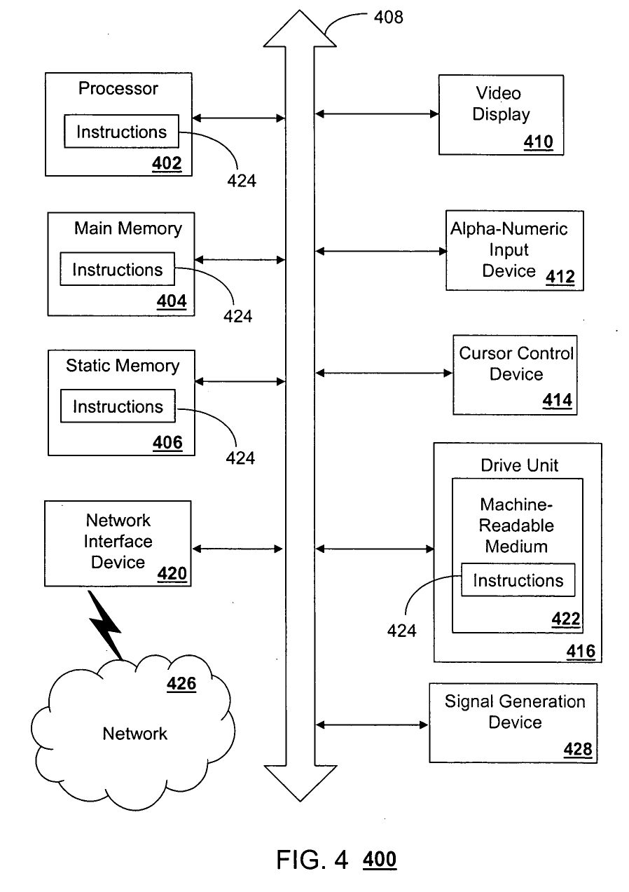

FIG. 4 is a diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated in herein above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A network proxy, comprising:
a communications interface;
a memory; and
a controller programmed to:
receive from a mobile device on a data channel of a communications network a mobile originated call for connecting to a terminal device;
transmit a first network originated call to the terminal device over a first voice channel;
transmit a second network originated call to the mobile device over a second voice channel; and
link the first and second voice channels.

2. The network proxy of claim 1, wherein the controller is programmed to:
receive a registration request from the mobile device on the data channel; and
register the mobile device.

3. The network proxy of claim 1, wherein the controller is programmed to:
receive a connection acceptance from the terminal device; and
receive a connection acceptance from the mobile device.

4. The network proxy of claim 3, wherein the controller is programmed to:
inform the mobile device of the connection acceptance with the terminal device; and
terminate the connection to the mobile device on the data channel.

5. The network proxy of claim 1, wherein the mobile originated call comprises an third party identifier for identifying the terminal device, and wherein the controller is programmed to:
retrieve a network identifier corresponding to the third party identifier; and
transmit the first network originated call according to the network identifier.

6. The network proxy of claim 1, wherein the controller is programmed to:
replace a mobile device caller identification (ID) received from the mobile device with a corresponding caller ID; and
transmit the caller ID with the first network originated call.

7. The network proxy of claim 1, comprising a media gateway for linking the first and second voice channels.

8. The network proxy of claim 1, wherein the network proxy comprises an IP Multimedia Subsystem (IMS).

9. A computer-readable storage medium in a network proxy, comprising computer instructions for:
receiving from a mobile device on a packet network a mobile originated call comprising an enterprise identifier for identifying a terminal device;
retrieving a network identifier corresponding to the enterprise identifier;
transmitting a first network originated call to the terminal device over a first voice channel according to the network identifier;
transmitting a second network originated call to the mobile device over a second voice channel; and
linking the first and second voice channels.

10. The storage medium of claim 9, comprising computer instructions for:
receiving a connection acceptance from the terminal device;
informing the mobile device of the connection acceptance; and
terminating the connection to the mobile device on the packet network.

11. The storage medium of claim 9, comprising computer instructions for:
replacing a mobile device caller identification (ID) received from the mobile device with a corresponding enterprise caller ID; and
transmitting the enterprise caller ID with the first network originated call.

12. The storage medium of claim 9, comprising computer instructions for causing a media gateway to link the first and second voice channels.

13. A mobile device, comprising:
a transceiver;
an audio system;
a memory; and
a controller programmed to:
establish a data channel connection with a communications network;
transmit over the data channel a mobile originated call to a network proxy to establish voice connectivity with a terminal device;
receive a network originated call from the network proxy over a voice channel; and
accepting the network originated call.

14. The mobile device of claim 13, wherein the controller is programmed to suppress an audible alert responsive to the network originated call.

15. The mobile device of claim 13, wherein the controller is programmed to transmit to the network proxy on the data channel a registration request.

16. The mobile device of claim 13, wherein the controller is programmed to:
receive an acknowledgment from the network proxy corresponding to an accepted voice channel connection with the terminal device; and
terminate the connection to the data channel.

17. The mobile device of claim 13, wherein the controller is programmed to transmit in the mobile originated call an abbreviated third party identifier for identifying the terminal device.

18. A method, comprising the step of simulating a mobile originated call as a network originated call.

19. The method of claim 18, comprising the steps of:
at a network proxy,
receiving from a mobile device on a data channel of a communications network a mobile originated call to connect to a terminal device;
transmitting a first network originated call to the terminal device over a first voice channel;
transmitting a second network originated call to the mobile device over a second voice channel;
linking the first and second voice channels; and
at the mobile device,
establishing the data channel connection with the network proxy;
transmitting the mobile originated call to the network proxy to establish connectivity with the terminal device;
receiving the second network originated call; and
accepting the second network originated call.

20. The method of claim 19, comprising the steps of:
at the network proxy,
replacing a mobile device caller identification (ID) received from the mobile device with a corresponding caller ID;
transmitting the caller ID with the first network originated call;
receiving a connection acceptance from the terminal device;
informing the mobile device of the connection acceptance; and
at the mobile device,
receiving the connection acceptance from the network proxy;
terminating the connection to the data channel of the communications network.

21. The method of claim 19, comprising the step of suppressing an audible alert at the mobile device responsive to the second network originated call.
